(19) United States
(12) Patent Application Publication
(10) Pub. No.: US 2021/0303178 A1
(43) Pub. Date: Sep. 30, 2021

(54) DISTRIBUTED STORAGE SYSTEM AND STORAGE CONTROL METHOD

(71) Applicant: Hitachi, Ltd., Tokyo (JP)

(72) Inventors: Yoshinori Ohira, Tokyo (JP); Akira Yamamoto, Tokyo (JP); Ryosuke Tatsumi, Tokyo (JP); Takahiro Yamamoto, Tokyo (JP); Masakuni Agetsuma, Tokyo (JP)

(73) Assignee: Hitachi, Ltd., Tokyo (JP)

(21) Appl. No.: 17/019,471

(22) Filed: Sep. 14, 2020

(30) Foreign Application Priority Data
Mar. 27, 2020 (JP) 2020-058088

(51) Int. Cl. G06F 3/06

(52) U.S. Cl. CPC G06F 3/0619; G06F 3/067; G06F 3/0683; G06F 3/0653; G06F 3/0659; G06F 3/0635

(57) ABSTRACT

Provided are: one or plural storage units including a plurality of physical storage devices (PDEVs); and a plurality of computers connected to the one or plural storage units via a communication network. Two or more computers execute storage control programs (hereinafter, control programs), respectively. Two or more control programs share a plurality of storage areas provided by the plurality of PDEVs and metadata regarding the plurality of storage areas. When the control program fails, another control program sharing the metadata accesses data stored in a storage area. When a PDEV fails, the control program restores data of the failed PDEV using redundant data stored in another PDEV that has not failed.

### BACKGROUND OF THE INVENTION

### 1. Field of the Invention

The present invention relates generally to storage control in a distributed storage system.

### 2. Description of the Related Art

In recent years, software-defined storage (SDS), which constructs a storage system with a general-purpose server, has become the mainstream. In addition, as one mode of SDS, hyper converged infrastructure (HCI) that bundles an application and storage control software on a general-purpose server has been widely recognized. Hereinafter, a storage system in which HCI is adopted as one mode of SDS is referred to as “SDS/HCI system”.

Meanwhile, as a technique to effectively utilize a flash device that enables high-speed data read, a non-volatile memory express over fabric (NVMe-oF) technique, which is a protocol for high-speed data communication via a network, has been widely used. With the use of this protocol, it becomes possible to perform the high-speed data communication even with the flash device via the network. On the basis of such a background, a drive box type product called fabric-attached bunch of flash (FBOF), which aims at integrating flash devices on a network, has also appeared in the market.

In the SDS/HCI system, data protection is performed by creating redundant data by a plurality of servers in cooperation and storing the redundant data in a direct-attached storage (DAS) mounted in each server, in order to prevent data loss when a server fails. As a data protection method, not only redundant array of independent (or inexpensive) disks (RAID), which have been used for a long time in storage systems, but also erasure coding (EC) is used. WO 2016/052665 discloses an EC method of reducing the amount of data to be transferred to another server via a network when writing data. In addition, WO 2016/052665 discloses a technique that uses data protection performed between DASs in the same server and data protection performed between DASs of a plurality of servers together for the purpose of efficiently recovering data when a drive fails.

In the SDS/HCI system, when a server fails, a technique to recover data of the failed server to another server and make it accessible is generally used. WO 2018/29820 discloses a technique that migrates an app and data used by the app to another server by data copying for the purpose of eliminating a server bottleneck as well as a server failure.

### SUMMARY OF THE INVENTION

In a general distributed storage system, a storage performance resource (for example, a central processing unit (CPU)) and a storage capacity resource (for example, a drive) are included in the same server, so that it is difficult to independently scale storage performance and storage capacity. For this reason, it is necessary to mount an extra storage performance resource or storage capacity resource depending on a performance requirement and a capacity requirement, and the resources are wasted, resulting in an increase in system cost. In addition, when an app is migrated between servers for the purpose of load distribution or the like, it is also necessary to migrate data used by the app. Thus, the load on the network becomes high, and it takes time to migrate the app between servers.

A distributed storage system is constituted by one or plural storage units including a plurality of physical storage devices and a plurality of computers connected to the one or plural storage units via a communication network. Two or more computers among the plurality of computers executes storage control programs, respectively. Two or more storage control programs share a plurality of storage areas provided by the plurality of physical storage devices and metadata regarding the plurality of storage areas. Each of the two or more storage control programs receives a write request specifying a write destination area in a logical unit provided by the storage control program from an application that recognizes the logical unit; makes data associated with the write request redundant based on the metadata; and writes one or more redundant data sets, which are the data made redundant, to one or more storage areas (for example, one or more redundant configuration areas to be described later) provided by two or more physical storage devices serving as a basis of the write destination area. When the storage control program fails, another storage control program sharing the metadata accesses data stored in a storage area. When a physical storage device fails, the storage control program restores data of the failed physical storage device using redundant data stored in another physical storage device that has not failed.

According to the invention, data can be made redundant without data transfer between computers in a distributed storage system, in other words, data can be protected with network efficiency.

### BRIEF DESCRIPTION OF THE DRAWINGS

FIG. 1 is a diagram illustrating an outline of a distributed storage system according to an embodiment of the invention;

FIG. 2 is a diagram illustrating an outline of a distributed storage system according to a comparative example;

FIG. 3 is a diagram illustrating an outline of a drive failure recovery according to the embodiment of the invention;

FIG. 4 is a diagram illustrating an outline of a server failure recovery according to the embodiment of the invention;

FIG. 5 is a diagram illustrating a hardware configuration example of a server, a management server, and a drive box according to the embodiment of the invention;

FIG. 6 is a diagram illustrating an example of divisions of the distributed storage system according to the embodiment of the invention;

FIG. 7 is a view illustrating a configuration example of a domain group management table according to the embodiment of the invention;

FIG. 8 is a diagram illustrating an example of drive area management according to the embodiment of the invention;

FIG. 9 is a view illustrating a configuration example of a chunk group management table according to the embodiment of the invention;

FIG. 10 is a view illustrating a configuration example of a page mapping table according to the embodiment of the invention;

FIG. 11 is a view illustrating a configuration example of a free page management table according to the embodiment of the invention;

FIG. 12 is a diagram illustrating an example of a table arrangement according to the embodiment of the invention;

FIG. 13 is a view illustrating an example of flow of a read process according to the embodiment of the invention;

FIG. 14 is a view illustrating an example of flow of a write process according to the embodiment of the invention;

FIG. 15 is a view illustrating an example of flow of a drive addition process according to the embodiment of the invention;

FIG. 16 is a view illustrating an example of flow of a drive failure recovery process according to the embodiment of the invention;

FIG. 17 is a view illustrating an example of flow of a server failure recovery process according to the embodiment of the invention;

FIG. 18 is a view illustrating an example of flow of a server addition process according to the embodiment of the invention; and

FIG. 19 is a view illustrating an example of flow of an owner server migration process according to the embodiment of the invention.

### DESCRIPTION OF THE PREFERRED EMBODIMENTS

In the following description, a “communication interface device” may be one or more communication interface devices. The one or more communication interface devices may be one or more homogeneous communication interface devices (for example, one or more network interface cards (NICs)), or may be two or more heterogeneous communication interface devices (for example, NIC and a host bus adapter (HBA)).

In addition, in the following description, a “memory” is one or more memory devices as an example of one or more storage devices, and typically may be a main storage device. At least one memory device in the memory may be a volatile memory device or a non-volatile memory device.

In addition, a “storage unit” is an example of a unit including one or more physical storage devices, in the following description. The physical storage device may be a persistent storage device. The persistent storage device may be typically a non-volatile storage device (for example, auxiliary storage device), and, specifically, may be a hard disk drive (HDD), a solid state drive (SSD), a non-volatile memory express (NVMe) drive, or a storage class memory (SCM), for example. In the following description, a “drive box” is an example of the storage unit and a “drive” is an example of the physical storage device.

In addition, a “processor” may be one or more processor devices in the following description. The at least one processor device may be typically a microprocessor device such as a central processing unit (CPU), but may be another type of processor device such as a graphics processing unit (GPU). The at least one processor device may be a single-core or multi-core processor. At least one processor device may be a processor core. At least one processor device may be a processor device in a broad sense such as a circuit that is an aggregation of gate arrays in a hardware description language that performs some or all of processes (for example, a field-programmable gate array (FPGA), a complex programmable logic device (CPLD), or an application specific integrated circuit (ASIC)).

In addition, information with which an output can be obtained for an input is sometimes described using the expression such as “xxx table” in the following description, but the information may be data of any structure (for example, structured data or unstructured data) or may be a learning model represented by a neural network that generates an output for an input, a genetic algorithm, or a random forest. Therefore, the “xxx table” can be referred to as an “xxx information”. In addition, in the following description, a configuration of each table is an example, one table may be divided into two or more tables, or all or some of two or more tables may be one table.

In addition, there is a case where processing is described with a “program” as a subject in the following description, but the subject of the processing may be a processor (or a device such as a controller having the processor) since the program is executed by the processor to perform the prescribed processing appropriately using a memory and/or a communication interface device. The program may be installed on a device such as a computer from a program source. The program source may be a recording medium (for example, a non-transitory recording medium) readable by, for example, a program distribution server or a computer. In addition, in the following description, two or more programs may be realized as one program, or one program may be realized as two or more programs.

In addition, in the following description, a common sign (or a reference sign) among reference signs is used in the case of describing the same type of elements without discrimination, and reference signs (or identifiers of the elements) are used in the case of discriminating the same type of elements.

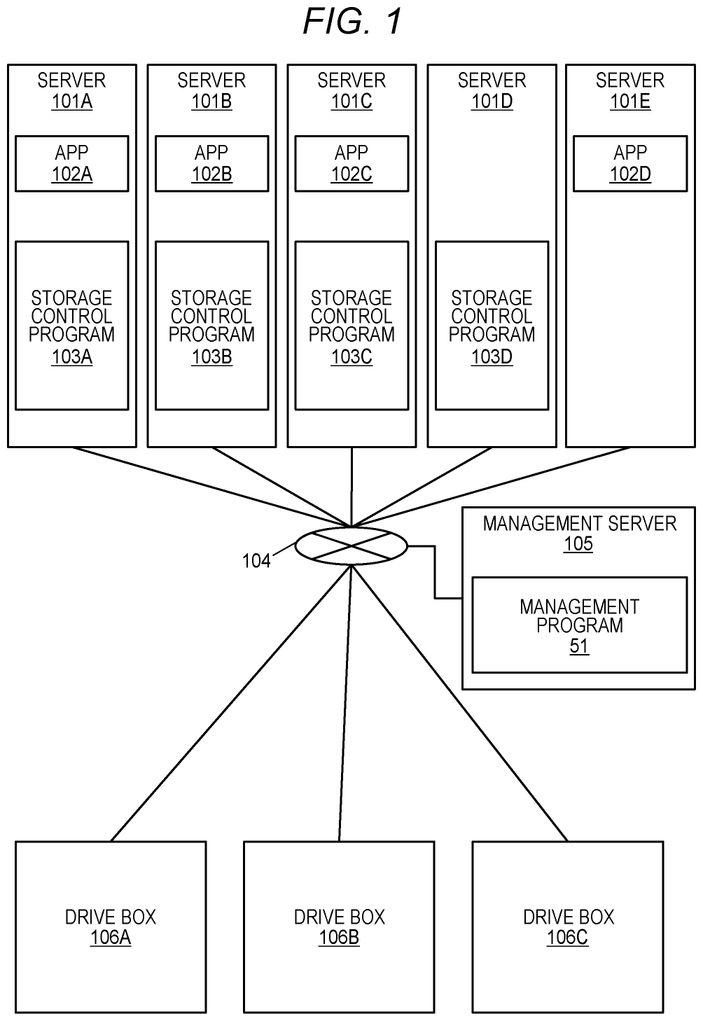

FIG. 1 is a diagram illustrating an outline of a distributed storage system according to an embodiment of the invention.

The distributed storage system according to the present embodiment is a storage system having a “drive-separated distributed storage configuration” that collects SDS and DAS of HCI in a drive box 106 such as FBOF connected to a general-purpose network 104. Since data is collected in the drive box 106, it is possible to independently scale storage performance and storage capacity.

In this configuration, each of servers 101 can directly access a drive mounted in the drive box 106, and each drive is shared among the servers 101. For this reason, each of the servers 101 can individually perform data protection for its own responsible data (data written by the corresponding server 101) without cooperating with another server 101. In addition, the servers 101 share metadata regarding a data protection method (for example, a RAID configuration and a data arrangement pattern (arrangement pattern of data and a parity)) for each chunk group (group constituted by two or more chunks each of which is a drive area in the drive box (details will be described later)). As a result, when the assignment of responsible data is changed between the servers 101, information associating the responsible data and a chunk group as a storage destination of the responsible data is copied to a change destination server 101, so that the data protection can be continued without data copying via the network 104.

In the present embodiment, one of the plurality of servers 101 constituting the distributed storage system is a representative server 101, the representative server 101 determines a RAID configuration and a data arrangement pattern for each chunk of an additional drive at the time of adding the drive, the metadata is shared between the servers 101, and at least one chunk group (for example, at least one out of one or more new chunk groups and one or more existing chunk groups) includes at least chunks of the additional drive. When writing data in a chunk group, each of the servers 101 associates the data with the chunk group, and individually performs data protection based on the above-described metadata without cooperating with another server 101.

When the assignment of the responsible data is changed between the servers 101, information, which represents an association between the responsible data and the chunk group owned by a migration source server 101 (the server 101 which has been responsible for the responsible data), is copied to a migration destination server 101 (the server 101 which is newly responsible for the responsible data). Thereafter, the migration destination server 101 individually performs data protection based on the metadata representing the chunk group of the responsible data without cooperation between the servers 101.

The distributed storage system of the present embodiment is constituted by the plurality of servers 101 (for example, 101A to 101E) connected to the network 104, a plurality of the drive boxes 106 (for example, 106A to 106C) connected to the network 104, and a management server 105 connected to the network 104. The distributed storage system of the present embodiment may be an example of the SDS/HCI system. In each of the servers 101, a single storage control program 103 and a plurality (or a single) apps 102 coexist to operate. However, it is unnecessary for all the servers 101 in the distributed storage system to include both the app 102 and the storage control program 103, and some servers 101 do not necessarily include one of the app 102 and the storage control program 103. Even a case where there is the server 101 that has the app 102 but does not have the storage control program 103, or the server 101 that has the storage control program 103 but does not have the app 102 is effective as the distributed storage system of the present embodiment. The “app” is an abbreviation for an application program. The “storage control program” may be referred to as storage control software. The “server 101” may be an abbreviation for a node server 101. Each of a plurality of general-purpose computers may execute predetermined software, and the plurality of computers may be constructed as software-defined anything (SDx). For example, a software-defined storage (SDS) or a software-defined datacenter (SDDC) can be adopted as the SDx. The server 101 is an example of the computer. The drive box 106 is an example of the storage unit.

Although a virtual machine or a container can be considered as an execution base of the app 102, the execution base of the app 102 is independent of the virtual machine or the container.

Data to be written from the app 102 is stored in any of the drive boxes 106A to 106C connected to the network 104 via the storage control program 103. For the network 104, a general-purpose network technique such as Ethernet and Fiber Chunnel can be used. The network 104 may connect the server 101 and the drive box 106 directly or via one or more switches. A general-purpose technique such as Internet SCSI (iSCSI) and NVMe-oF can be used for a communication protocol.

The storage control program 103 of each of the servers 101 cooperates with each other to operate and constitute the distributed storage system in which the plurality of servers 101 are bundled. For this reason, when a certain server 101 fails, the storage control program 103 of another server 101 can substitute the processing and continue the I/O. Each of the storage control programs 103 can have a data protection function and a storage function of a snapshot or the like.

The management server 105 has a management program 51. The management program 51 may be referred to as management software. The management program 51 includes, for example, information representing a configuration of the chunk group in the above-described metadata. A process performed by the management program 51 will be described later.

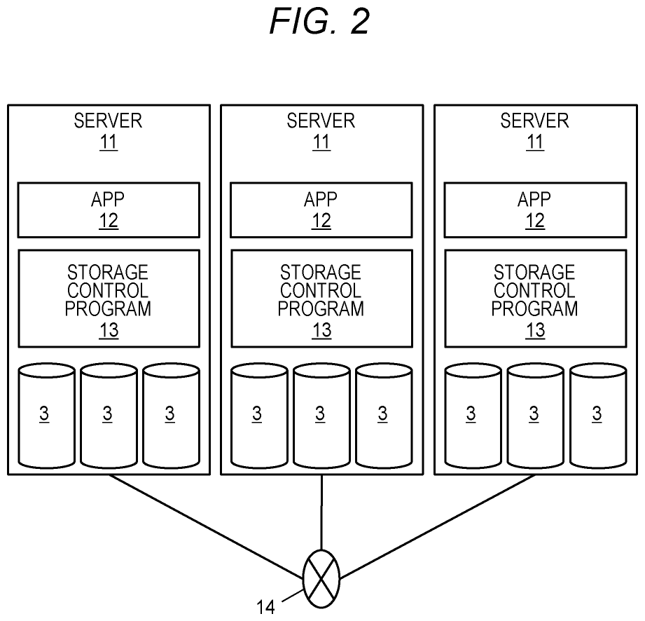

FIG. 2 is a diagram illustrating an outline of a distributed storage system according to a comparative example.

According to the distributed storage system of the comparative example, each of a plurality of servers 11 includes a direct-attached storage (DAS), for example, a plurality of drives 3 in addition to the app 12 and the storage control program 13. In order to prevent data loss when a server fails, each of the servers 11 cooperates with another server 11 to perform data protection. For the data protection, data is transferred between the servers 11 via the network 14. For example, the server 11 writes data to the drive 3 in the server 11, transfers a copy of the data to the other server 11 via the network 14, and the other server 11 writes the data copy to the drive 3 in the other server 11.

On the other hand, it is unnecessary to transfer protection target data between the servers 101 via the network 14 for data protection according to the distributed storage system (see FIG. 1) of the present embodiment. In addition, when the storage control program 106 fails, another storage control program 106 sharing the metadata may access the data stored in the chunk. When a drive fails, the storage control program 106 may restore data of the failed drive using redundant data stored in another drive that has not failed.

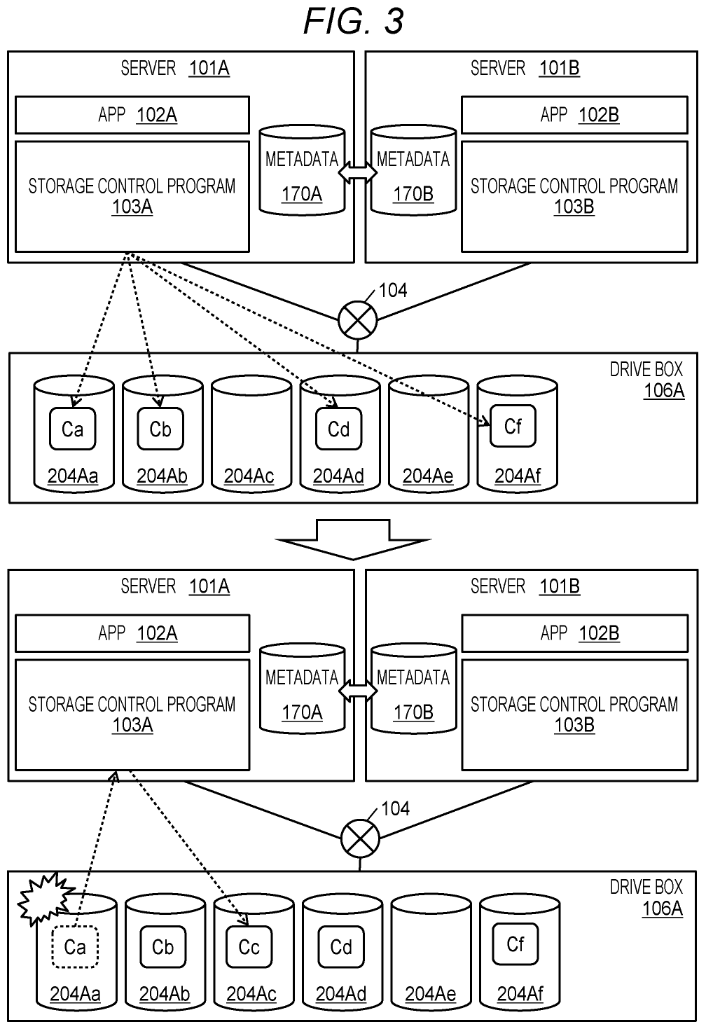

FIG. 3 is a diagram illustrating an outline of a drive failure recovery according to the embodiment of the invention.

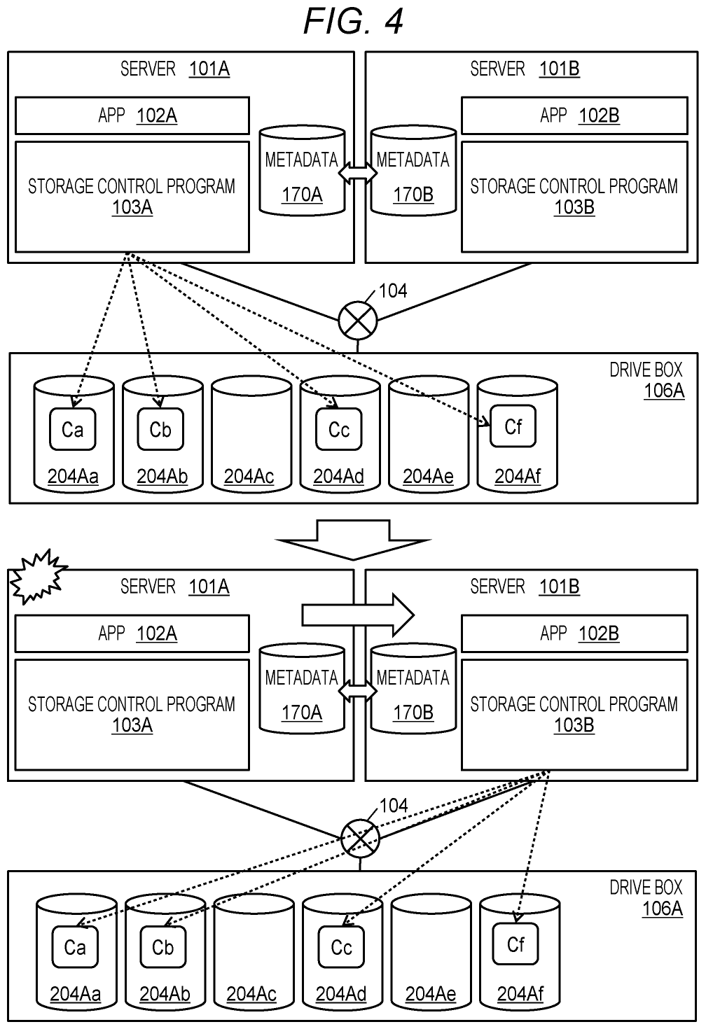

The servers 101A and 101B and the drive box 106A as representatively illustrated in FIG. 3 (and FIG. 4 to be described later). The drive box 106A includes a plurality of drives 204A (for example, 204Aa to 204Af).

A plurality of chunk groups are provided based on the drive box 106A. The chunk group is a group constituted by two or more chunks. Two or more chunks that form the same chunk group are two or more drive areas respectively provided by two or more different drives 204A. In the present embodiment, one chunk is provided by one drive 204A and does not straddle two or more different drives 204A. According to the example illustrated in FIG. 3, the drive 204Aa provides a chunk Ca, the drive 204Ab provides a chunk Cb, the drive 204Ad provides a chunk Cd, and the drive 204Af provides a chunk Cf. Those chunks Ca, Cb, Cd, and Cf constitute one chunk group. According to the example illustrated in FIG. 3, one chunk group is provided by one drive box 106A, but at least one chunk group may straddle two or more different drive boxes 106.

The server 101A has a storage control program 103A that provides a logical unit (LU) (not illustrated), and an app 102A that writes data to the LU. The server 101B has a storage control program 103B and an app 102B.

The storage control program 103A refers to metadata 170A. The storage control program 103B refers to metadata 170B. The metadata 170A and the metadata 170B are synchronized. That is, when one of the metadata 170A and 170B is updated, the update is reflected in the other metadata. That is, the metadata 170A and 170B are maintained to have the same content. In this manner, the storage control programs 103A and 103B share metadata 170. Note that the metadata 170A and 170B may be present in the servers 101A and 101B, respectively, or the metadata 170 may be present in a shared area accessible by both the servers 101A and 101B.

The metadata 170A and 170B represent a chunk group configuration and a data protection method (an example of a data redundancy method) for each chunk group. For example, when receiving a write request specifying an LU provided by itself from the app 102A, the storage control program 103A refers to the metadata 170A to identify that the chunk group is constituted by the chunks Ca, Cb, Cd, and Cf and that the data protection method of the chunk group RAID level 5 (3D+1P). For this reason, the storage control program 103A makes data associated with the write request redundant according to RAID level 5 (3D+1P), and writes a redundant data set, which is the data made redundant, to the chunk group. The “redundant data set” is constituted by a plurality of data elements. The data element may be either a “user data element” that is at least a part of data from the app 102 or a “parity” that is generated based on two or more user data elements. Since the data protection method is RAID level 5 (3D+1P), the redundant data set is constituted by three user data elements and one parity. For example, three user data elements are written in three chunks Ca, Cb, and Cd respectively, and one parity is written in one chunk Cf.

Thereafter, it is assumed that a failure occurs in any of the drives 204A, for example, the drive 204Aa. In this case, for each of one or more data elements stored in the drive 204Aa and respectively included in the one or more redundant data sets, the storage control program 103 that has written the data element performs the following processing. For example, the storage control program 103A that has written the user data element in the chunk Ca restores the user data element from a user data element other than the user data element and a parity in the redundant data set including the user data element based on the metadata 170A, and writes the restored user data element to a drive other than the drives 204Aa, 204Ab, 204Ad, and 204Af storing the redundant data set. Specifically, for example, one of the following processes may be performed.

Although not illustrated in FIG. 3, the storage control program 103A writes a redundant data set including the restored user data element to a chunk group based on two or more drives 204 other than the failed drive 204Aa. In this case, a reconfiguration of a chunk group is not required.

As illustrated in FIG. 3, the storage control program 103A writes the restored user data element to the chunk Cc of the drive 204Ac (an example of the drive other than the drives 204Aa, 204Ab, 204Ad, and 204Af). Then, the storage control program 103A changes a configuration of a chunk group holding the redundant data set including the user data element, specifically, replaces the chunk Ca with the chunk Cc in the chunk group. In this manner, the reconfiguration of the chunk group is required in this case.

In FIG. 3, the “chunk Cc” is an example of one chunk out of the two or more chunks provided by the drive 204Ac. The “drive 204Ac” is an example of any drive 204A other than the drives 204Aa, 204Ab, 204Ad, and 204Af. The “drive 204Aa” is an example of the drive 204 in which the failure has occurred. Each of the drives 204Ab, 204Ad, and 204Af is an example of the drive storing the data element of the redundant data set.

FIG. 4 is a diagram illustrating an outline of a server failure recovery according to the embodiment of the invention.

The storage control program 103A (an example of each of the two or more storage control programs 103) manages a page mapping table (an example of mapping data) for an LU provided by itself. The page mapping table is a table representing the correspondence between an LU area and a page. The “LU area” is a partial storage area in an LU. The “page” is a storage area as a part (or whole) of a chunk group, and is a storage area having a part (or whole) of each of two or more chunks constituting the chunk group as a component. For example, when an LU is newly created in the present embodiment, the storage control program 103 identifies a free page as many as the number of all LU areas (page in an allocable state that has not yet been allocated to any LU area), and allocates the free page to the LU. The storage control program 103A registers that the page has been allocated to the LU area in the page mapping table. The storage control program 103 writes a redundant data set of data accompanying a write request to a chunk group including the page allocated to the write destination LU area.

It is assumed that a failure occurs in any of the servers 101, for example, the server 101A. In this case, for each of the one or more LUs provided by the storage control program 103A in the server 101A, the storage control program 103B in the server 101B selected as a recovery destination server 101 of the LU recovers the LU based on a page mapping table regarding the LU (for example, the page mapping table received from the storage control program 103A), and provides the recovered LU to the app 102B. The storage control program 103B can read data according to one or more redundant data sets from the page allocated to the LU area of the recovered LU by referring to the page mapping table. In other words, for each of the one or more LUs provided by the storage control program 103A, the server 101B can access the data of the LU without data migration via the network 104 even if an owner server of the LU (server responsible for I/O with respect to the LU) is changed from the server 101A to the server 101B.

Hereinafter, the present embodiment will be described in detail.

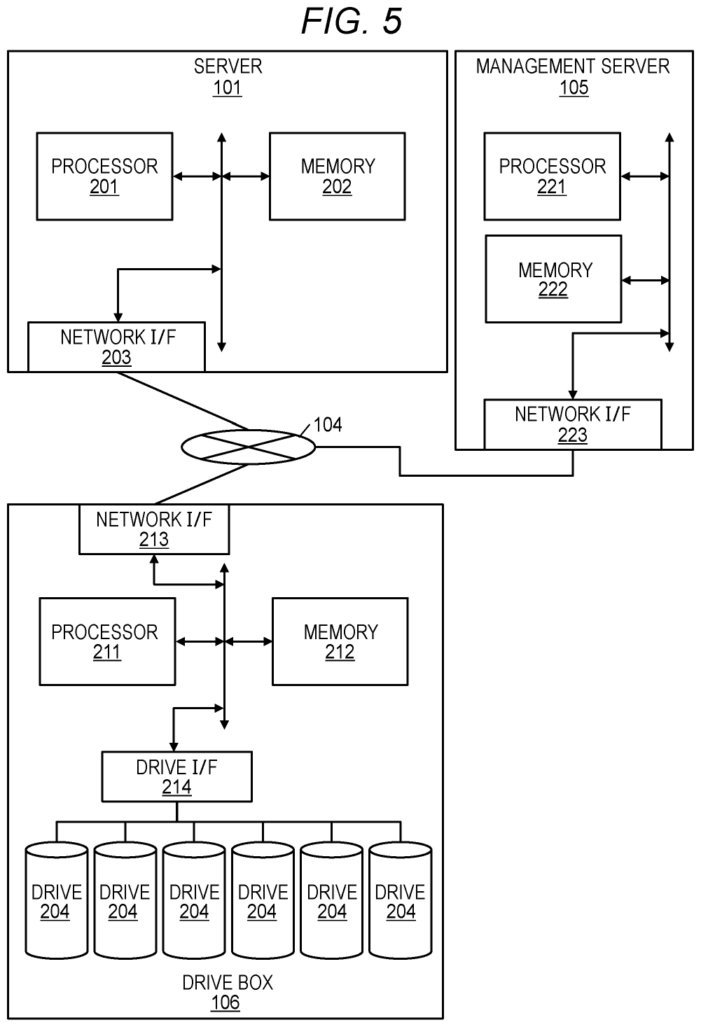

FIG. 5 is a diagram illustrating a hardware configuration example of the server 101, the management server 105, and the drive box 106 according to the present embodiment.

The server 101 has a memory 202, a network I/F 203 (an example of the communication interface device), and a processor 201 connected to the memory 202 and the network I/F 203. At least one of the memory 202, the network I/F 203, and the processor 201 may be multiplexed (for example, duplexed). The memory 202 stores the app 102 and the storage control program 103, and the processor 201 executes the app 102 and the storage control program 103.

Similarly, the management server 105 also has a memory 222, a network I/F 223 (an example of the communication interface device), and a processor 221 connected to the memory 222 and the network I/F 223. At least one of the memory 222, the network I/F 223, and the processor 221 may be multiplexed (for example, duplexed). The memory 222 stores the management program 51, and the processor 221 executes the management program 51.

The drive box 106 has a memory 212, a network I/F 213, a drive I/F 214, and a processor 211 connected to the memory 212, the network I/F 213, and the drive I/F 214. The network I/F 213 and the drive I/F 214 are examples of the communication interface device. The plurality of drives 204 are connected to the drive I/F 214. The server 101, the management server 105, and the drive box 106 are connected to the network 104 via the network I/Fs 203, 223, and 221, and can communicate with each other. The drive 204 may be a general-purpose drive such as a hard disk drive (HDD) and a solid state drive (SSD). Of course, the invention is independent of a drive type and a form factor, and other types of drives may be used.

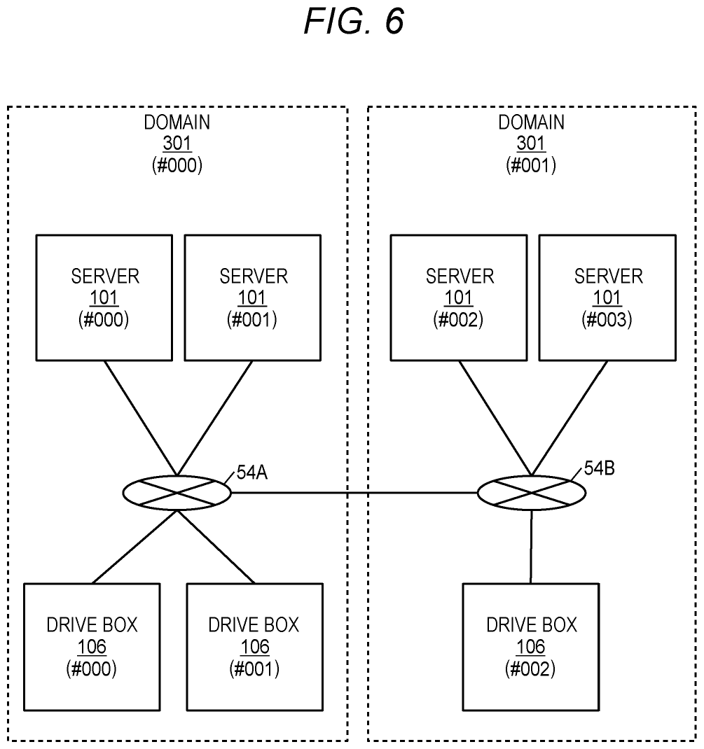

FIG. 6 is a diagram illustrating an example of divisions of the distributed storage system according to the present embodiment.

The distributed storage system may be divided into a plurality of domains 301. That is, the server 101 and the drive box 106 may be managed in units called “domains”. In this configuration, data to be written to an LU by the app 102 is stored in any drive box 106 belonging to the same domain 301 as the server 101 on which the app 102 operates via the storage control program 103. For example, write target data generated in servers 101(#000) and 101(#001) belonging to a domain 301(#000) is stored in one or both of drive boxes 106(#000) and 106(#001) via a sub network 54A, and write target data generated in servers 101(#002) and 101(#003) belonging to a domain 301(#001) is stored in a drive box 106(#002). As the distributed storage system is configured using the domains in this manner, it becomes possible to separate the server performance influence between the domains 301 when a failure occurs in the drive box 106 or the drive 204.

For example, according to the example illustrated in FIG. 6, the network 104 includes sub networks 54A and 54B (an example of a plurality of sub communication networks). The domain 301(#000) (an example of each of the plurality of domains) includes the servers 101(#000) and 101(#001) and the drive boxes 106(#000) and 106(#001) connected to the sub network 54A corresponding to the domain 301(#000), and does not include the servers 101(#002) and 101(#003) and the drive box 106(#002) connected to the sub network 54A via the other sub network 54B. As a result, even if the sub networks 54A and 54B are disconnected, it is possible to maintain read of data written in the drive box 106 in each range of the domains 301(#000) and 301(#001).

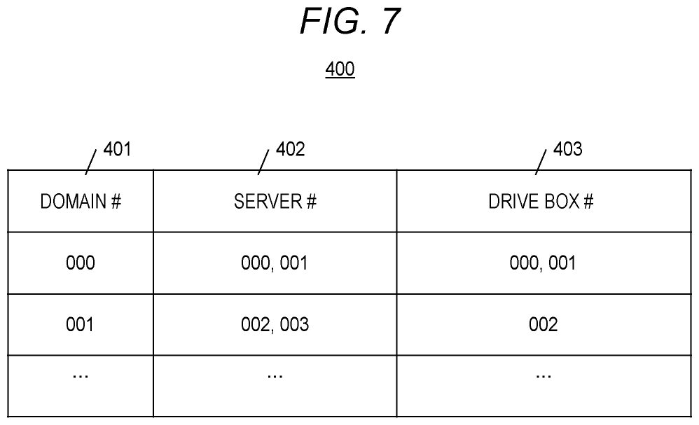

FIG. 7 is a view illustrating a configuration example of a domain management table 400.

The domain management table 400 is a table configured to manage a server group and a drive box group constituting the domain 301 for each of the domains 301. The domain management table 400 has a record for each of the domains 301. Each record holds information such as a domain #401, a server #402, and a drive box #403. One domain 301 is taken as an example (“target domain 301” in the description of FIG. 7).

The domain #401 represents an identifier of the target domain 301. The server #402 represents an identifier of the server 101 belonging to the target domain. The drive box #403 represents an identifier of the drive box 106 belonging to the target domain.

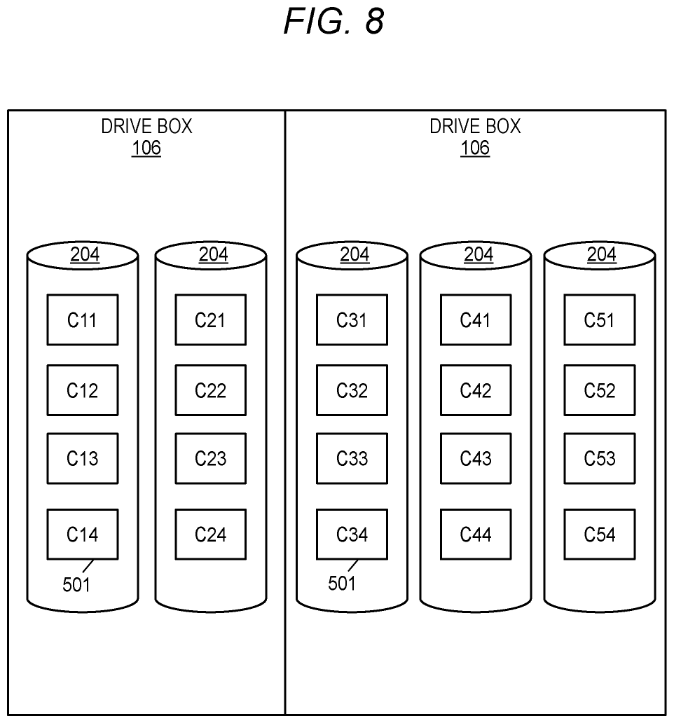

FIG. 8 is a diagram illustrating an example of drive area management according to the present embodiment.

In the present embodiment, the plurality of drives 204 mounted in the drive box 106 are managed in the state of being divided into a plurality of fixed size areas called “chunks” 501. In the present embodiment, a chunk group, which is a storage area combining a plurality of chunks belonging to a plurality of different drives, has a RAID configuration. A plurality of data elements constituting a redundant data set are written to the chunk group according to a RAID level (data redundancy level and a data arrangement pattern) according to the RAID configuration of the chunk group. According to the RAID configuration of the chunk group, data protection is performed using a general RAID/EC technique. In the description of the present embodiment, the terms related to the storage area are defined as follows.

The “chunk” is a part of the entire storage area provided by one drive 204. One drive 204 provides a plurality of chunks.

The “chunk group” is a storage area constituted by two or more different chunks provided by two or more different drives 204, respectively. The “two or more different drives 204” that provide one chunk group may be closed in one drive box 106 or may straddle two or more drive boxes 106.

The “page” is a storage area that is constituted by a part of each of two or more chunks constituting a chunk group. The page may be the chunk group itself, but one chunk group is constituted by a plurality of pages in the present embodiment.

A “strip” is a part of the entire storage area provided by one drive 204. One strip stores one data element (user data element or parity). The strip may be the smallest unit of storage area provided by one drive 204. That is, one chunk may be constituted by a plurality of strips.

A “stripe” is a storage area constituted by two or more different strips provided by two or more different drives 204 (for example, two or more strips with the same logical address). One redundant data set may be written in one stripe. That is, two or more data elements constituting one redundant data set may be written in two or more strips constituting one stripe, respectively. The stripe may be a whole or a part of a page. In addition, the stripe may be a whole or a part of a chunk group. In the present embodiment, one chunk group may be constituted by a plurality of pages, and one page may be constituted by a plurality of stripes. A plurality of stripes forming a chunk group may have the same RAID configuration as a RAID configuration of the chunk group.

The “redundant configuration area” may be an example of any of the stripe, the page, and the chunk group.

The “drive area” may be an example of a device area, and specifically may be an example of either the strip or the chunk, for example.

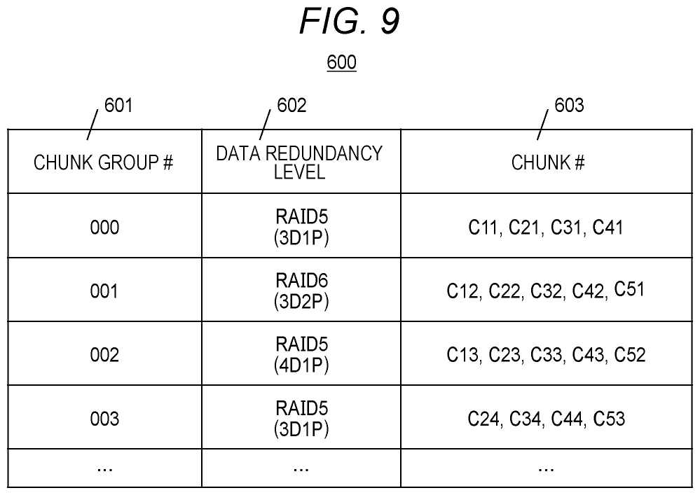

FIG. 9 is a diagram illustrating a configuration example of a chunk group management table 600.

The chunk group management table 600 is a table configured to manage a configuration of each chunk group and a data protection method (RAID level). The chunk group management table 600 is at least a part of the metadata 170 as will be described later. The chunk group management table 600 has a record for each chunk group. Each record holds information such as a chunk group #601, a data redundancy level 602, and a chunk #603. One chunk group is taken as an example (“target chunk group” in the description of FIG. 9).

The chunk group #601 represents an identifier of the target chunk group. The data redundancy level 602 represents a data redundancy level (data protection method) of the target chunk group. The chunk #603 represents an identifier of a chunk as a component of the target chunk group.

According to the example illustrated in FIG. 9, it can be understood that a chunk group #000 is constituted by four chunks (C11, C21, C31, and C41) and protected by RAID5 (3D+1P).

The chunk group management table 600 is shared by the plurality of servers 101 as at least a part of the metadata 170. For this reason, when data is written from any server 101 to any chunk group, data protection can be performed according to a data redundancy level of the chunk group.

Note that the data arrangement pattern is often determined according to the data redundancy level, and thus, the description thereof is omitted.

In addition, in the present embodiment, at least one storage control program 103 (for example, the storage control program 103 in the representative server 101) may newly configure a chunk group dynamically (for example, according to a write amount with respect to a drive, in other words, according to the free space of one or more configured chunk groups), and add information on the newly configured chunk group to the chunk group management table 600. As a result, it is expected that the chunk group with the optimum data redundancy level is configured according to a situation of the distributed storage system, that is, the optimization of the data redundancy level of the chunk group. Specifically, for example, the following configuration may be adopted.

A chunk management table may be prepared. The chunk management table may be shared by the plurality of storage control programs 103. For each chunk, a chunk management group may present a drive that provides the chunk, a drive box having the drive, and a state of the chunk (for example, whether the chunk is a free state that does not serve as a component of any chunk group).

When a condition for newly create a chunk group is satisfied (for example, when the free space of one or more created chunk groups becomes less than a predetermined value), the storage control program 103 (or the management program 51) may newly create a chunk group constituted by two or more different free chunks respectively provided by two or more different drives 204. The storage control program 103 (or the management program 51) may add information indicating a configuration of the chunk group to the chunk group management table 600. The storage control program 103 may write one or more redundant data sets according to write target data in the newly created chunk group. As a result, it is expected to create the chunk group with the optimum data redundancy level while avoiding the exhaustion of the chunk group.

The storage control program 103 (or the management program 51) may determine a data redundancy level (RAID level) of a chunk group, to be created, according to a predetermined policy. For example, if the free space in a drive box is a predetermined value or more, the storage control program 103 (or the management program 51) may set a data redundancy level of a chunk group to be newly created to RAID6 (3D+2P). If the free space in the drive box is less than the predetermined value, the storage control program 103 (or the management program 51) may set the data redundancy level of the chunk group to be newly created to a data redundancy level (for example, RAIDS (3D +1P)) that can be realized with fewer chunks as compared to the case where the free space in the drive box is the predetermined value or more.

In the present embodiment, a plurality of chunk groups may be configured in advance based on all the drives 204 included in all the drive boxes 106.

In the present embodiment, a chunk group related to chunks in the entire area of a drive may be configured at the time of adding the drive as will be described later. The addition of the drive may be performed in units of drives or in units of drive boxes.

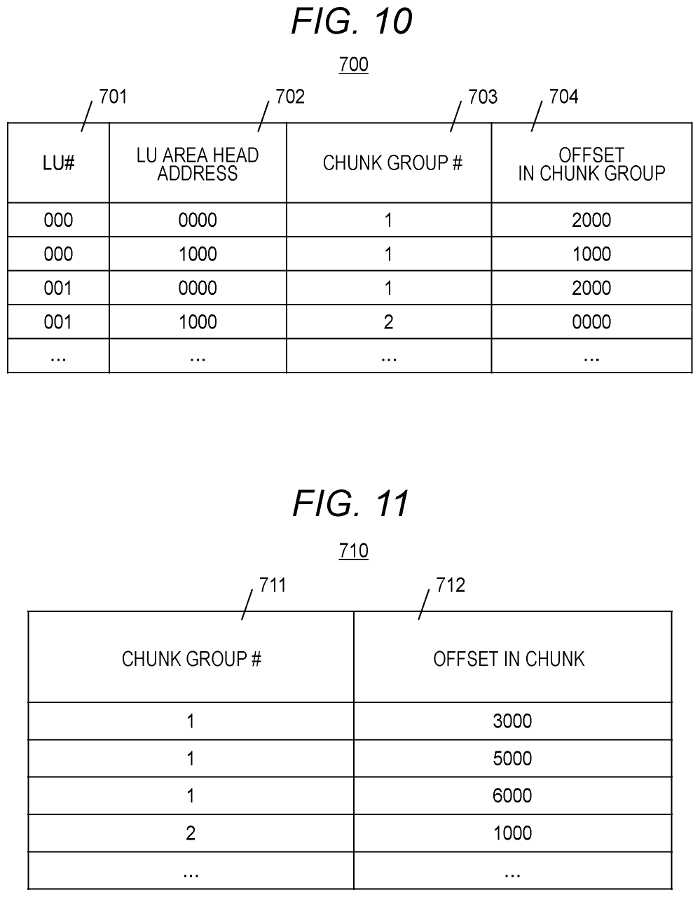

FIG. 10 is a diagram illustrating a configuration example of a page mapping table 700.

As described above, a write area is provided to the app 102 in units called logical units (LUs) in the present embodiment. An area of each chunk group is managed by a page, which is a fixed size area smaller than a chunk group, and is associated with an LU area. The page mapping table 700 is a table configured to manage the correspondence between an LU area and a page (a partial area of a chunk group). In the present embodiment, pages are assigned to all areas of an LU at the time of creating the LU, but a technique called thin provisioning may be used to dynamically allocate pages to write destination LU areas.

The page mapping table 700 has a record for each LU area. Each record holds information such as an LU #701, an LU area head address 702, a chunk group #703, and an offset in chunk group 704. One LU area is taken as an example (“target LU area” in the description of FIG. 10).

The LU #701 represents an identifier of an LU including the target LU area. The LU area head address 702 represents a head address of the target LU area. The chunk group #703 represents an identifier of a chunk group including a page allocated to the target LU area. The offset in chunk group 704 represents a position of the page allocated to the target area (difference from a head address of a chunk group including the page to a head address of the page).

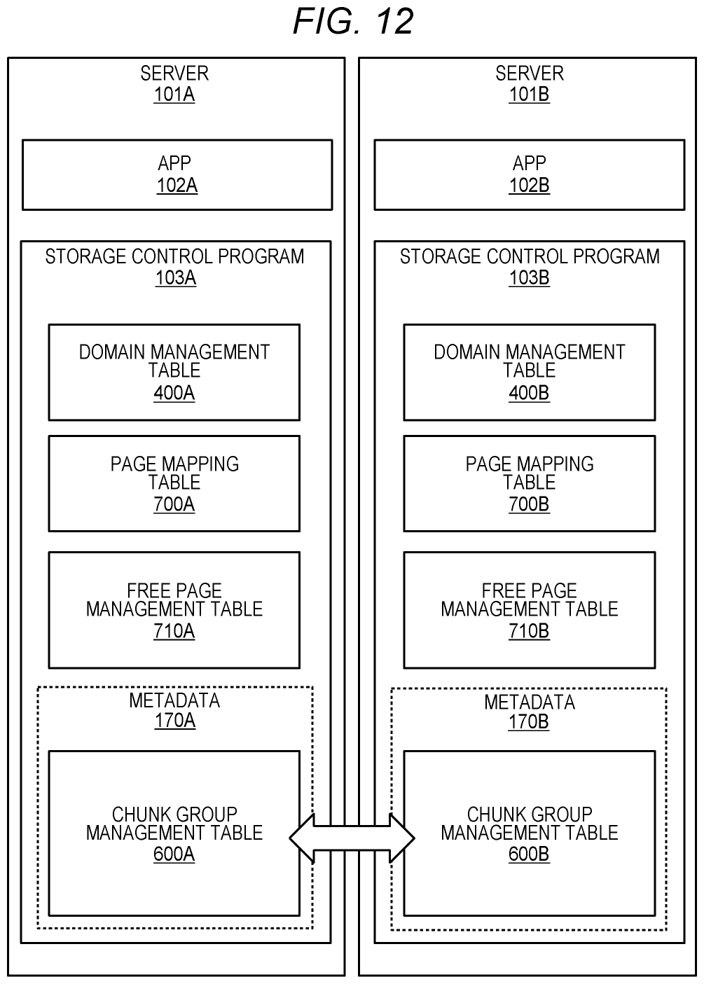

FIG. 11 is a view illustrating a configuration example of a free page management table 710.

The free page management table 710 is a table configured to manage a free page that can be allocated to an LU without causing each of the servers 101 to communicate with the other server 101. The free page management table 710 has a record for each free page. Each record holds information such as a chunk group #711 and an offset in chunk group 712. One free page is taken as an example (“target free page” in the description of FIG. 11).

The chunk group #711 represents an identifier of a chunk group including the target free page. The offset in chunk group 712 represents a position of the target free page (difference from a head address of a chunk group including the target free page to a head address of the target free page).

A free page is assigned to each of the servers 101 by the representative server 101 (or the management server 105), and information on the allocated free pages is added to the table 710. In addition, a record of the free page allocated to an LU created at the time of creating the LU is deleted from the table 710. When free pages of a certain server 101 are insufficient, the representative server 101 (or the management server 105) creates a new chunk group, and an area in the chunk group is added to the certain server 101 as a new free page. That is, for each of the servers 101, the free page management table 710 held by the server 101 holds information regarding a page that has been allocated to be allocable to the LU provided by the server 101 among a plurality of pages provided by all the drive boxes 106 accessible by the server 101, in the server 101.

Details of the page allocation control during the LU creation and a sequence of the free page control are not described.

FIG. 12 is a diagram illustrating an example of a table arrangement according to the present embodiment.

Hereinafter, the server 101A will be described as an example of one server. The description regarding the server 101A can be applied to each of the other servers 101 (for example, the server 101B).

First, the server 101A may hold a domain management table 400A that represents a plurality of domains which are a plurality of divisions of the distributed storage system.

Further, the server 101A owns a page mapping table 700A related to an LU used by the app 102 that is being run by itself and a free page management table 710A that holds information on a free page allocated to the server 101A as the free page allocable to the LU. In other words, the server 101A does not necessarily have the all page mapping tables of all the servers 101. This is because the amount of management data owned by each of the servers 101 becomes enormous to affect scalability if all the page mapping tables of all the servers 101 are shared by all the servers 101. However, the page mapping table 700A may be backed up to some of the other servers 101 constituting the distributed storage system in order to cope with loss of management data when a server fails. In the present embodiment, the “management data” may be data held by the storage control program 103, and may include the domain management table 400A, the page mapping table 700A, the free page management table 710A, and the metadata 170A. The metadata 170A may include a chunk group management table 600A. The page mapping table 700A has information on one or more LUs provided by the storage control program 103A, but may exist for each LU.

Hereinafter, for a certain LU, a server that owns a page mapping table portion of the LU is called an owner server. The owner server can access metadata regarding the LU at high speed and can perform high-speed I/O. For this reason, a configuration in which an app that uses the LU is arranged in the owner server will be described in the description of the present embodiment. However, it is possible to arrange the app in a server different from the owner server and perform I/O on the owner server.

The chunk group management table 600A is synchronized between the servers 101 running the storage control program. For this reason, the same configuration information (same content) can be referred to by all the servers 101. As a result, when migrating an app and an LU from the server 101A to the other server 101B, there is no need to reconfigure a user data element and a parity (in other words, need to copy data via the network 104). Even without such a reconfiguration (data copy), it is possible to continue data protection even at the server to which the application and the LU are migrated.

The storage control program 103 may refer to the domain management table 400A and the chunk group management table 600A to identify a chunk group provided by one or more drive boxes 106 in the same domain as a data write destination. In addition, the storage control program 103 may also refer to the domain management table 400A and the chunk group management table 600A to identify two or more free chunks provided by one or more drive boxes 106 in the same domain (two or more free chunks provided by two or more different drives), configure a chunk group with the two or more free chunks (at that time, for example, determine a data redundancy level of the chunk group according to a situation of the distributed storage system), and add information on the chunk group to the chunk group management table 600A. Which chunk is provided from the drive 204 of which drive box 106 may be identified by, for example, any of the following methods.

Information of the drive 204 that provides the chunk and the drive box 106 that has the drive 204 is added for each chunk in the chunk group management table 600.

A chunk identifier includes an identifier of the drive 204 that provides the chunk and an identifier of the drive box 106 that has the drive 204.

Hereinafter, some processes performed in the present embodiment will be described. In the following description, the app 102A is taken as an example of the app 102, and the storage control program 103A is taken as an example of the storage control program 103.

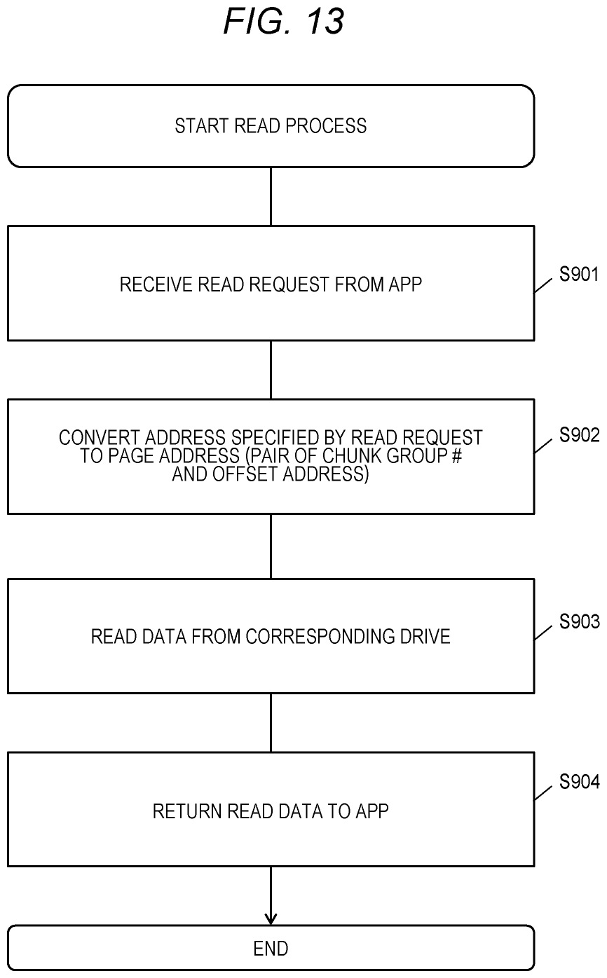

FIG. 13 is a view illustrating an example of flow of a read process.

The storage control program 103A receives a read request specifying an LU used by the app 102A (LU provided by the storage control program 103A) from the app 102A (S901). The storage control program 103A uses the page mapping table 700A to convert an address specified by the read request (for example, a pair of an LU # and an LU area address) to a page address (a pair of a chunk group # and an offset address in chunk group) (S902). Thereafter, the storage control program 103A reads one or more redundant data sets from two or more drives 204 which serve as the basis of a page to which the page address belongs (S903), and constructs read target data from the one or more read redundant data sets to return the read target data to the app 102A (S904).

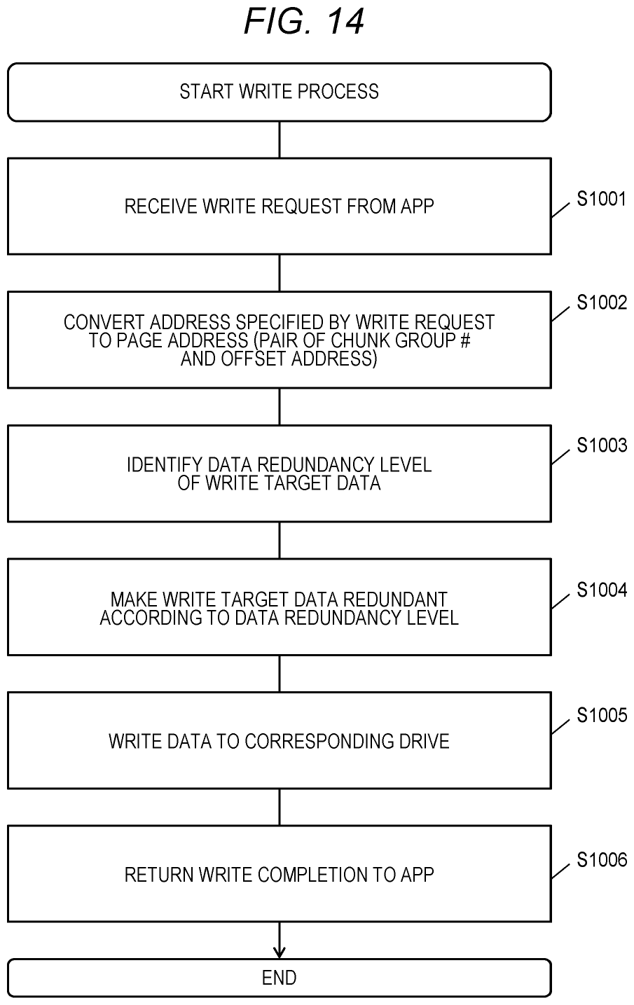

FIG. 14 is a view illustrating an example of flow of a write process.

The storage control program 103A receives a write request specifying an LU from the app 102A (S1001). The storage control program 103A uses the page mapping table 700A to convert an address specified by the write request (for example, a pair of an LU # and an LU area address) to a page address (a pair of a chunk group # and an offset address in chunk group) (S1002). The storage control program 103A identifies a data redundancy level of the chunk group # in the page address using the chunk group management table 600A (S1003). The storage control program 103A creates one or more redundant data sets in which the write target data is made redundant according to the identified data redundancy level (S1004). Finally, the storage control program 103A writes the one or more created redundant data sets in the two or more drives 204 which serve as the basis of the page to which the page address obtained in 51002 belongs (S1005), and returns write completion to the app 102A (S1006).

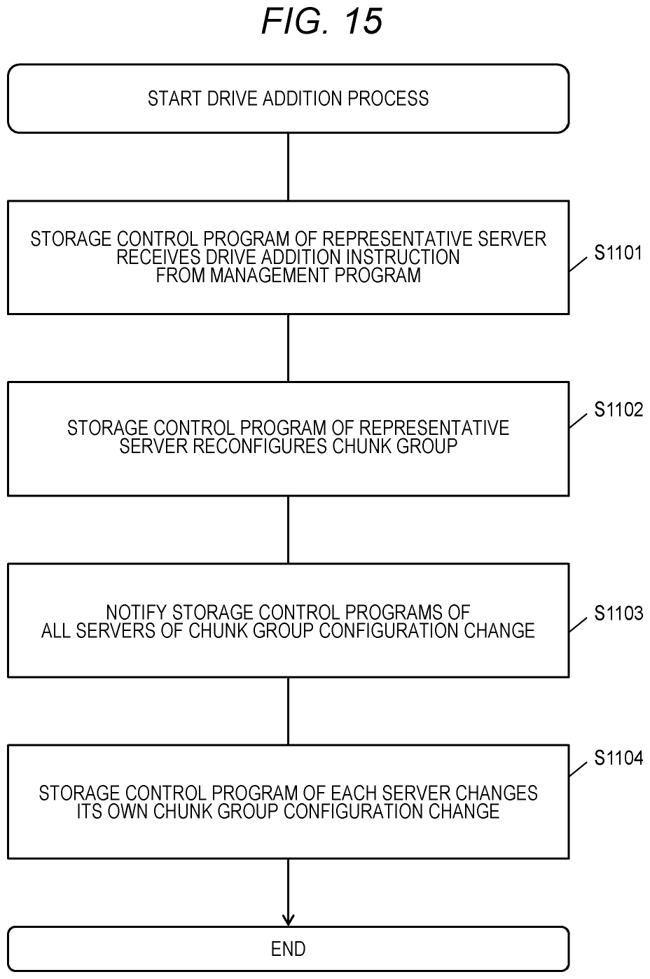

FIG. 15 is a view illustrating an example of flow of a drive addition process.

First, the storage control program 103A of the representative server 101A receives a drive addition instruction from the management program 51 (S1100). The storage control program 103A of the representative server 101A reconfigures a chunk group based on a drive configuration after the addition, and updates the chunk group management table 600A with information indicating a plurality of chunk groups after the reconfiguration (S1102).

The storage control program 103A notifies the storage control programs 103 of all the servers 101 of the configuration change of the chunk group (S1103). The storage control program 103 of each of the servers 101 changes its own chunk group configuration change according to the notification content (S1104). That is, with 51103 and 51104, the content of the chunk group management table 600 of each of the servers 101 becomes the same content as the updated chunk group management table 600A.

Note that the chunk group reconfiguration in 51102 may be performed as follows, for example. That is, the storage control program 103A defines each chunk of all the added drives 204. Each chunk defined here is called an “additional chunk”. The storage control program 103A performs the chunk group reconfiguration using a plurality of additional chunks. The chunk group reconfiguration may include at least one of a rebalancing process of equalizing the number of chunks constituting a chunk group (reconstructing chunks constituting a chunk group) and a process of creating a new chunk group using the additional chunks.

Since the chunk group reconfiguration is performed as the drive is added, it is possible to expect that the chunk group configuration is maintained at the optimum configuration even if the drive is added.

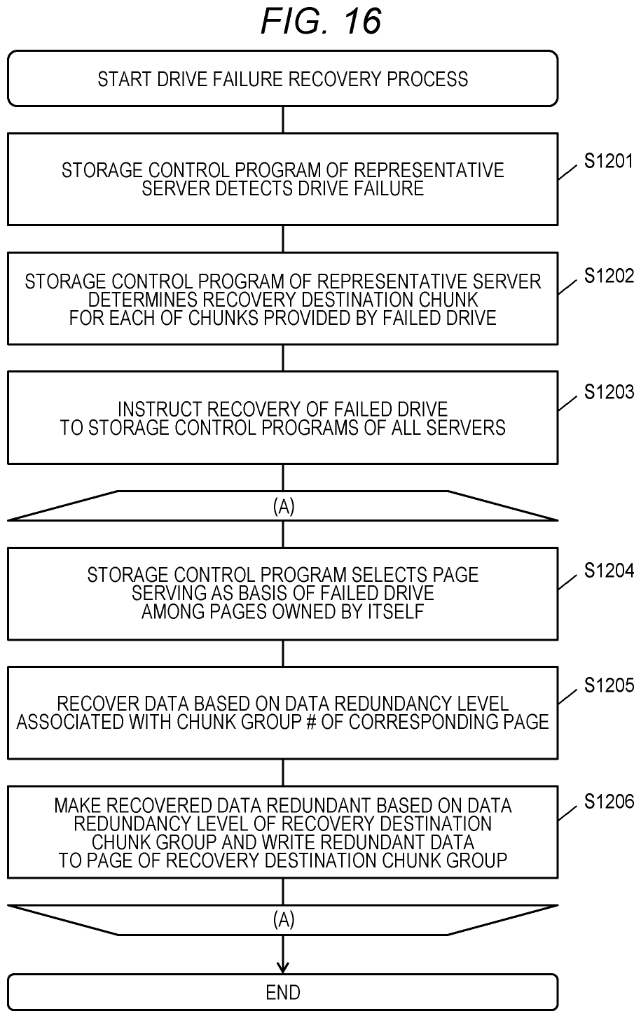

FIG. 16 is a view illustrating an example of flow of a drive failure recovery process.

First, the storage control program 103A of the representative server 101A detects a drive failure (S1201). Each chunk provided by a failed drive (drive in which the drive failure has occurred) is hereinafter referred to as a “failed chunk”. The storage control program 103A refers to the chunk group management table 600A to select a recovery destination chunk for each failed chunk (S1202). The chunk group management table 600A may hold information on a free chunk that does not belong to any chunk group (for example, information for each free chunk including an identifier of the free chunk, an identifier of a drive that provides the free chunk, and an identifier of the drive). For each failed chunk, a chunk selected as a recovery destination chunk is a free chunk provided by the drive 204 that does not provide any chunk of the chunk group including the failed chunk. In other words, for each failed chunk, no chunk in the chunk group including the failed chunk is selected as the recovery destination chunk.

The storage control program 103A instructs the storage control programs 103 of all the servers 101 to recover the failed drive (S1203). In the instruction, for example, a page address of a page including a part of the failed chunk is specified.

The storage control program 103 of each of the servers 101 that has received the instruction performs S1204 to S1206 that belong to the loop (A). S1204 to S1206 are performed for each page indicated by the page address specified by the instruction (that is, the page serving as the basis of the failed drive) among pages allocated to LUs owned by the storage control program 103. That is, the storage control program 103 refers to the page mapping table 700 to select the page indicated by the page address specified by the instruction among the pages allocated to the LUs owned by itself (S1204). The storage control program 103 identifies a data redundancy level corresponding to a chunk group # included in the page address from the chunk group management table 600, and recovers data from the page selected in S1204 based on the identified data redundancy level (S1205). The storage control program 103 makes the recovered data redundant based on the data redundancy level of the recovery destination chunk group, and writes the redundant data (one or more redundant data sets) to a page of the recovery destination chunk group (S1206).

Note that the “recovery destination chunk group” referred to herein is a chunk group based on two or more drives 204 other than the failed drive. According to the example illustrated in FIG. 16, the data, obtained by making the recovered data redundant, is written in the free page based on two or more drives other than the failed drive, and thus, the drive failure recovery is possible without performing the chunk group reconfiguration.

As described above, a data element recovered based on the data redundancy level (data element in the failed chunk) may be written with any chunk, which is not included in a chunk group in which the redundant data set including the data element is stored, as a recovery destination chunk. In this case, the chunk group reconfiguration may be performed in which the failed chunk in the chunk group is replaced with the recovery destination chunk.

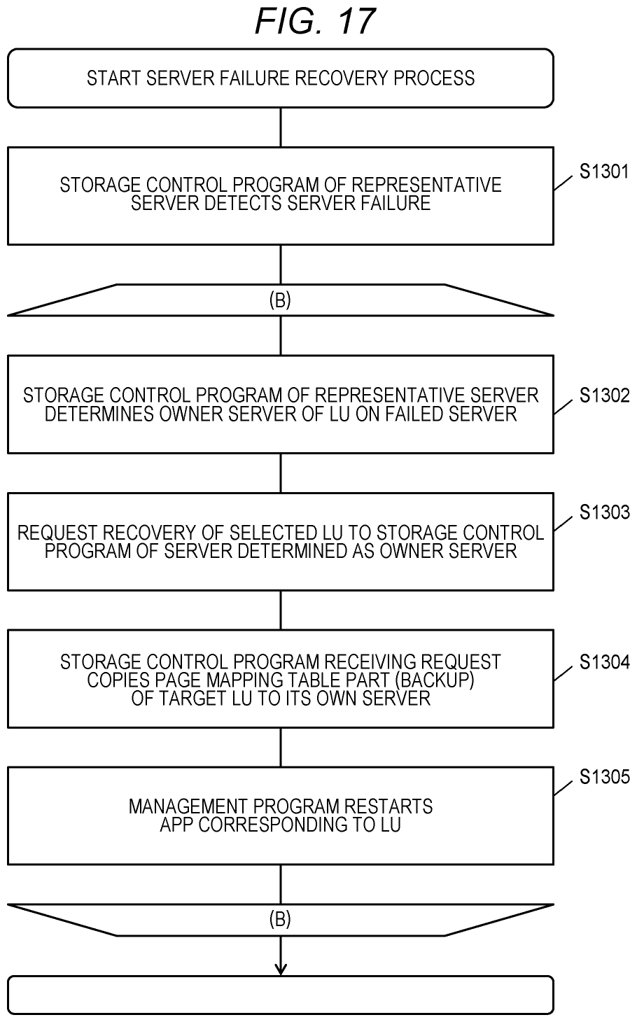

FIG. 17 is a view illustrating an example of flow of a server failure recovery process.

The storage control program 103A of the representative server 101A detects a server failure (S1301). Next, the storage control program 103A of the representative server 101A performs S1302 to S1305 for each LU in a failed server (server in which the server failure has occurred). Hereinafter, one LU is taken as an example (“selected LU” in the description of FIG. 17). The app 102 that uses the selected LU is suspended by the management program 51, for example.

The storage control program 103A determines a migration destination server of an LU in the failed server, that is, a new owner server (S1302). Although details of a method for determining the owner server are omitted, the owner server may be determined such that an I/O load after migration becomes uniform among the servers. The storage control program 103A requests the storage control program 103 of the server, which is the owner server of the selected LU, to recover the selected LU (S1303).

The storage control program 103 that has received the recovery request copies a backup of a page mapping table portion corresponding to the selected LU stored in any of the servers to its own server 101 (S1304). The selected LU is recovered in the owner server based on this page mapping table portion. That is, a page allocated to the selected LU is allocated to a recovery destination LU of the selected LU, instead of the selected LU. In 51304, the storage control program 103 may be capable of receiving I/O with respect to the LU in the own server 101, instead of the selected LU, from the app by handing over information on the selected LU (for example, LU #) to any free LU in its own server 101 or by another method.

Finally, the management program 51 (or the storage control program 103A) restarts the app 102 that uses the selected LU (S1305).

In this manner, the server failure recovery can be performed without transferring the data written in the selected LU between the servers 101 via the network 104. Note that the app of the selected LU may be restarted in the new owner server. For example, a server that has an app (standby) corresponding to the app (active) in the failed server may be set as an owner server, and the app may be restarted in the owner server that has taken over the selected LU.

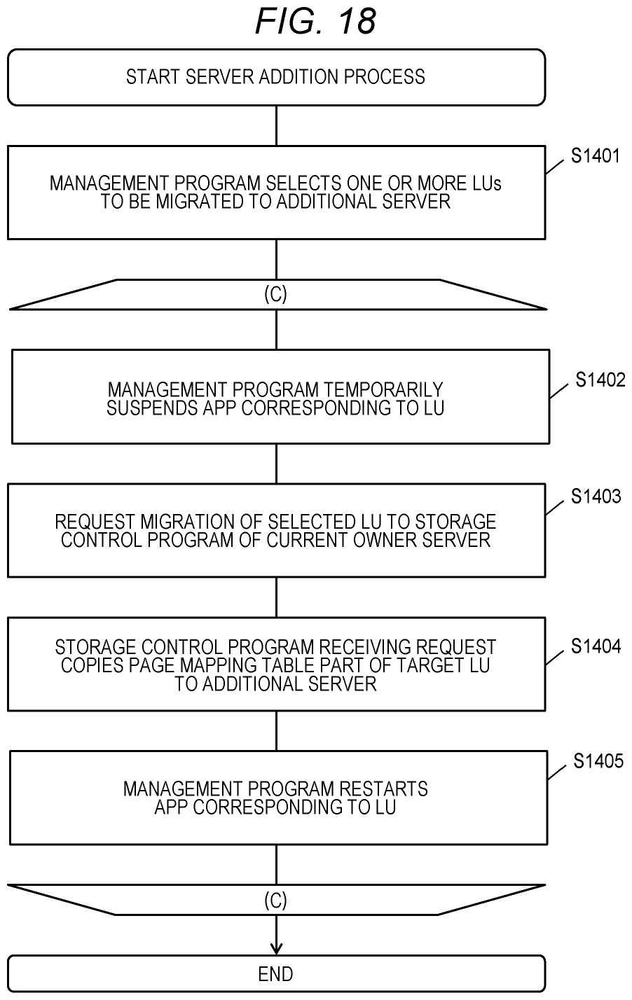

FIG. 18 is a view illustrating an example of flow of a server addition process.

The management program 51 selects one or more LUs to be migrated to an additional server (added server) (S1401). S1402 to 51405 are performed for each LU. Hereinafter, one LU is taken as an example (“selected LU” in the description of FIG. 18).

The management program 51 temporarily suspends the app that uses the selected LU (S1402). This prevents generation of I/O with respect to the selected LU. The management program 51 requests the storage control program 103 of a migration source server 101 (the current owner server 101) of the selected LU to migrate the selected LU (S1403).

The storage control program 103 that has received the request copies the page mapping table portion corresponding to the selected LU to the additional server 101 (S1404). The selected LU is recovered in the additional server based on this page mapping table portion. That is, a page allocated to the selected LU is allocated to a recovery destination LU of the selected LU, instead of the selected LU.

The management program 51 restarts the app corresponding to the selected LU (S1405).

In this manner, the server addition process can be performed without transferring the data written in the selected LU between the servers 101 via the network 104.

Note that the app of the migrated LU may also be migrated to the additional server.

In the server addition process, one or more apps may be selected instead of one or more LUs in S1401, and S1402 to S1405 may be performed for each selected app. That is, the management program 51 temporarily suspends the selected app in S1402. In S1403, for at least one LU used by the app, the management program 51 requests the storage control program 103 of the owner server to migrate an LU to the additional server. In S1404, the page mapping table portion corresponding to the LU is copied to the additional server. The app is restarted in S1405.

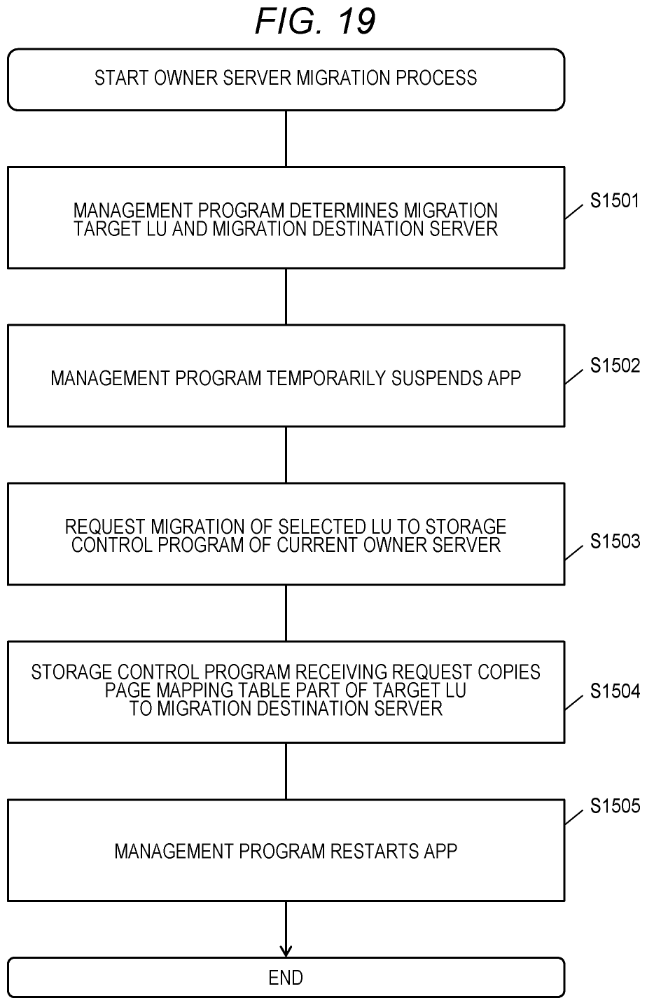

FIG. 19 is a view illustrating an example of flow of an owner server migration process.

The owner server migration process is a process of migrating one of an LU and an app to arrange both the LU and the app in the same server 101 when the LU and the app using the LU are not present in the same server 101. Hereinafter, the LU will be taken as an example of a migration target.

The management program 51 determines the migration target LU and a migration destination server (new owner server) (S1501).

The management program 51 suspends an app that uses the migration target LU (S1502). The management program 51 requests migration of the LU to the storage control program 103 of a current owner server of the migration target LU (S1503).

The storage control program 103 having received the request copies a page mapping table portion corresponding to the LU to the migration destination server (S1504).

The management program 51 restarts the app that uses the migration target LU (S1505).

In this manner, the owner server migration process can be performed without transferring data, which has been written in the migration target LU (change target LU of the owner server), between the servers 101 via the network 104.

Although the management program 51 executes partial processing in the owner server migration process and the server addition process, the storage control program 103 of the representative server 101A may execute the processing, instead of the management program 51.

Although the embodiment of the invention has been described above, the invention is not limited to the above embodiment. Those skilled in the art can easily modify, add, and change each element of the above embodiment within the scope of the invention.

A part or all of each of the above-described configurations, functions, processing units, processing means, and the like may be realized, for example, by hardware by designing with an integrated circuit and the like. Information such as programs, tables, and files that realize the respective functions can be stored in a storage device such as a nonvolatile semiconductor memory, a hard disk drive, and a solid state drive (SSD), or a computer-readable non-transitory data storage medium such as an IC card, an SD card, and a DVD.

1. A distributed storage system comprising:
one or plural storage units including a plurality of physical storage devices; and
a plurality of computers coupled to the one or plural storage units via a communication network, wherein
each of two or more computers among the plurality of computers execute a storage control program, and stores metadata regarding a plurality of storage areas provided by the plurality of physical storage devices,
two or more storage control programs among the storage control programs, when updating the metadata stored in a computer among the two or more computers, reflect the update in the metadata in each of the other computers among the two or more computers,
each of the two or more storage control programs is configured to, when receiving a write request specifying a write destination area in a logical unit provided by the storage control program, make data associated with the write request redundant based on the metadata, write one or more redundant data sets, which are the data made redundant, to one or more storage areas provided by two or more physical storage devices serving as a basis of the write destination area, and update the metadata stored in the computer executing the storage control programs,
a first computer which is a computer among the plurality of computers storing metadata regarding storage areas associated with a logical unit is selected as an owner server,
the storage control program in the first computer selected as the owner server about the logical unit is configured to perform I/O with respect to the logical unit,
when the storage control program in the first computer fails, the owner server is changed from the first computer to a second computer which is another computer among the plurality of computers, and the storage control program in the second computer accesses, using the metadata data stored in a storage area associated with the logical unit, and
when the physical storage device fails, the storage control program restores data in the failed physical storage device using redundant data stored in another physical storage devices that has not failed.

2. The distributed storage system according to claim 1, wherein
each of the plurality of physical storage devices provides two or more device areas which are two or more storage areas,
the plurality of storage areas are a plurality of redundant configuration areas,
the metadata represents a configuration of the redundant configuration area and a data protection method for each of the plurality of redundant configuration areas, and
each of the plurality of redundant configuration areas is a storage area in which a redundant data set is written, and is a storage area constituted by two or more device areas respectively provided by two or more physical storage devices among the plurality of physical storage devices.

3. The distributed storage system according to claim 2, wherein
a storage control program detecting that one or more physical storage devices have been added to one or more storage units, or that one or more storage units have been added performs a reconfiguration that is at least one of adding one or more redundant configuration areas and changing a configuration of one or more redundant configuration areas, and updates the metadata to data representing the configuration of the redundant configuration area after the reconfiguration.

4. The distributed storage system according to claim 1, wherein
when any physical storage device fails, a storage control program writing a data element restores the data element from a data element other than the data element in a redundant data set including the data element based on the metadata for each of one or plural data elements stored in the failed physical storage device and respectively included in one or plural redundant data sets, and writes the restored data element to any physical storage device other than the physical storage device storing the redundant data set.

5. The distributed storage system according to claim 1, wherein
each of the two or more storage control programs manages mapping data, which is data representing a correspondence between a storage area forming a logical unit and one or more storage areas based on two or more physical storage devices, for the logical unit provided by the storage control program, and
when any computer fails, for each of one or more logical units provided by a storage control program in the failed computer, the storage control program in a computer selected as a recovery destination computer of the logical unit recovers the logical unit based on the mapping data on the logical unit, and provides the recovered logical unit.

6. The distributed storage system according to claim 1, wherein
each of the two or more storage control programs manages mapping data, which is data representing a correspondence between a storage area forming a logical unit and one or more storage areas based on two or more physical storage devices, for the logical unit provided by the storage control program, and
when a computer is added, for at least one logical unit provided by a storage control program in any existing computer, a storage control program in the added computer receives mapping data of the logical unit from the storage control program in the existing computer, recovers the logical unit based on the mapping data, and provides the recovered logical unit.

7. The distributed storage system according to claim 1, wherein
each of the two or more storage control programs manages mapping data, which is data representing a correspondence between a storage area forming a logical unit and one or more storage areas based on two or more physical storage devices, for the logical unit provided by the storage control program, and
for at least one logical unit provided by a storage control program in any computer, a storage control program in a migration destination computer, which is a computer different from the computer and has an application that receives provision of the logical unit, receives mapping data of the logical unit from a storage control program in a migration source computer of the logical unit, constructs a logical unit as a migration destination of the logical unit based on the mapping data, and provides the constructed logical unit to the application.

8. The distributed storage system according to claim 1, further comprising a plurality of domains, wherein
each of the plurality of domains includes one or more computers and one or more storage units, and
for each of the storage control programs, a write destination of a redundant data set generated by the storage control program is two or more physical storage devices in a domain including the storage control program.

9. The distributed storage system according to claim 8, wherein
the communication network includes a plurality of sub communication networks, and
each of the plurality of domains includes one or more computers and one or more storage units connected to a sub communication network corresponding to the domain, and does not include one or more computers and one or more storage units connected to the sub communication network corresponding to the domain via one or more other sub communication networks.

10. The distributed storage system according to claim 1, wherein
at least one of the two or more storage control programs identifies two or more free device areas which do not serve as components of any redundant configuration area based on the metadata, configures a redundant configuration area with two or more identified free device areas, and adds information on the configured redundant configuration area to the metadata.

11. The distributed storage system according to claim 10, wherein
at least one of the two or more storage control programs identifies the two or more free device areas when free space of one or more configured chunk groups is identified to be less than a threshold based on the metadata.

12. A storage control method wherein
two or more storage control programs, executed by two or more computers among a plurality of computers constituting a distributed storage system, share a plurality of storage areas, and stores metadata regarding a plurality of storage areas provided by a plurality of physical storage devices in one or plural storage units connected to the plurality of computers via a communication network, and the metadata regarding the plurality of storage areas stored in a computer among the two or more computers, reflect the update in the metadata in each of the other computers among the two or more computers,
when a storage control program that provides a logical unit is configured to receive a write request specifying a write destination area in the logical unit provided by the storage control program the storage control program makes data associated with the write request redundant based on the metadata, write one or more redundant data sets, which are the data made redundant, to one or more storage areas provided by two or more physical storage devices serving as a basis of the write destination area, and update the metadata stored in the computer executing the storage control programs,
a first computer which is a computer among the plurality of computers storing metadata regarding storage areas associated with a logical unit is selected as an owner server,
the storage control program in the first computer selected as the owner server about the logical unit is configured to perform I/O with respect to the logical unit,
when the storage control program in the first computer fails, the owner server is changed from the first computer to a second computer which is another computer among the plurality of computers, and the storage control program in the second computer accesses, using the metadata data stored in a storage area associated with the logical unit, and
when the physical storage device fails, the storage control program restores data in the failed physical storage device using redundant data stored in another physical storage devices that has not failed.
